(19) United States
(12) Patent Application Publication
(10) Pub. No.: US 2024/0045462 A1
(43) Pub. Date: Feb. 8, 2024

(54) HUMAN-MACHINE INTERFACE, IN PARTICULAR FOR A VEHICLE OR FOR A DEVICE

(71) Applicant: Safran Electronics & Defense, Paris (FR)

(72) Inventors: Yannick Attrazic, Moissy-Cramayel (FR); Michael Nahmiyace, Moissy-Cramayel (FR); Albert Auphan, Moissy-Cramayel (FR); Philippe Bezivin, Moissy-Cramayel (FR); Etienne Zante, Moissy-Cramayel (FR)

(21) Appl. No.: 18/268,963

(22) PCT Filed: Dec. 16, 2021
(86) PCT No.: PCT/FR2021/052355

§ 371 Date: Jun. 21, 2023

(30) Foreign Application Priority Data
Dec. 22, 2020 (FR) FR2013953

(51) Int. Cl. G05G 9/047; G05G 25/00

(52) U.S. Cl. CPC G05G 9/047; G05G 25/00; G05G 2009/04774

(57) ABSTRACT

The present disclosure relates to a human-machine interface, in particular for a vehicle or for a device, comprising at least one gripping element comprising at least one transducer transmitting a command depending on at least one item of input information. The human-machine interface comprises at least one sensor and calculation means configured to determine a position of at least one interaction surface for interaction between an operator and the gripping element, the calculation means also being configured to determine whether the command is intentional by determining whether at least one first predefined surface lies at least partially within the interaction surface, so as to authorise the transmission of the command by the human-machine interface when it is determined that the command is intentional.

### TECHNICAL FIELD

The technical field of the invention is human-machine interfaces and more particularly such human-machine interfaces intended to be actuated by the hand of an operator.

### PRIOR ART

A stick is the human-machine interface element between a hand of an operator, such as a pilot, and an actuator of a vehicle or a device. The stick may integrate some functionalities such as, for example, the integration of buttons or the detection of the grip of the stick by the operator.

Such grip detection may be required for applications where it is necessary to be sure that an action on the stick is necessarily the consequence of an intentional action of the operator.

The buttons may be of different technologies, such as electromechanical, magnetic, etc., and are generally affixed on the stick, respectively arranged in a defined area. Their location is determined during the design of the stick. They cannot be repositioned unless a new stick design with different button locations is made.

The detection of the hand of the operator, also called “Hands On/Hands Off”, is conventionally carried out by means of a contactor. For example, it may consist of a pallet disposed in front of the stick which must be kept pulled to validate the commands.

The techniques currently implemented are essentially intrusive because they require a particular grip by the operator, thereby imposing the ergonomics of the stick.

Moreover, the ergonomics of the stick are relatively complex and time-consuming to develop. They are related to the shape of the stick, and to the position, shape, number and functionalities of the buttons disposed over the stick. Hence, the development of the ergonomics of the stick is complex and expensive.

From the prior art, there is known a force application device for an active mini-control stick. The French patent application 3086076 describes the main elements of a mini-control stick of an aircraft decoupled from the actuators of the aircraft, according to the technology of electric flight controls, also referred to by the acronym “FBW” standing for “Fly-by-Wire”. Such an electric flight control mini-control stick of an aircraft is provided with force feedback means to emulate the efforts felt by the pilot when using a similar mini-control stick directly coupled to the actuators of the aircraft.

The French patent application 3086079 is also known describing a multipoint tactile device with capacitive detection. This document discloses the main elements of a device for detecting presses and the position of such presses with respect to an array of capacitive elements and the signal emitted by each of the capacitive elements.

### DISCLOSURE OF THE INVENTION

In light of the foregoing, the invention aims to provide a human-machine interface ensuring a non-intrusive detection of the hand of the operator, with a relatively simple design and enabling a reconfiguration of an existing interface.

An object of the invention is a human-machine interface, in particular fora vehicle or for a device, comprising at least one gripping element for the transmission of a command, an instruction or a plurality of commands or instructions, according to at least one item of input information, in particular an angle of inclination or an angle of rotation of the gripping element with respect to a reference position and/or a force, an effort or a direction applied to the gripping element.

The human-machine interface comprises
at least one sensor, in particular a sensitive element or an array of sensitive elements, disposed over at least one portion of an external surface of the gripping element and configured to transmit a detection signal following an action carried out by an operator on the gripping element, and
calculation means configured to determine a position of at least one interaction surface between the operator and the gripping element.

According to the invention, the calculation means are also configured to determine whether the command is intentional by determining whether at least one first predefined surface is included at least partially in the interaction surface, so as to authorise the transmission of the command by the human-machine interface when it is determined that the command is intentional.

The sensor may be of the capacitive, resistive or inductive type.

Moreover, the human-machine interface may comprise at least one second predefined area distinct from the first predefined area. The calculation means are then configured to transmit the command associated with the second predefined area if the second predefined area is included at least partially in the interaction surface.

The human-machine interface may also comprise at least one directional contactor. The calculation means may then be configured to determine a pressed movement of the operator on the directional contactor in at least one predefined area according to an origin position, an end position of the pressed movement and to transmit a command different from the command emitted during a simple press on the predefined area.

The calculation means may also be configured to transmit a command associated with a simultaneous interaction on at least two predefined areas.

The human-machine interface may comprise
an informative layer comprising a delimitation and/or command indication associated with at least one predefined area;
means for illuminating at least one predefined area; and/or
information feedback means, in particular haptic, allowing warning the operator about a command associated with the predefined area, such as an activation, an unavailability or an error related to the command associated with the predefined area.

Another object of the invention is a vehicle, in particular an aircraft, a drone, a spacecraft, a construction machine, a motor vehicle or a ship, controlled by a human-machine interface as described hereinabove.

Of course, the different features, variants and/or embodiments of the invention may be associated together according to various combinations to the extent that they are not incompatible or exclusive of each other.

### BRIEF DESCRIPTION OF THE DRAWINGS

The invention will be better understood and other features and advantages will appear better upon reading the following detailed description comprising embodiments given for illustration with reference to the appended figures, presented as non-limiting examples, which could be used to complete the understanding of the invention and the disclosure of making thereof and, where appropriate, contribute to the definition thereof, wherein:

FIG. 1 illustrates a first embodiment of the human-machine interface according to the invention, and

FIG. 2 illustrates a second embodiment of the human-machine interface according to the invention.

### DETAILED DESCRIPTION

It should be noted that, in the figures, the structural and/or functional elements common to the different embodiments may have the same references. Thus, unless stated otherwise, such elements have identical structural, dimensional and material properties.

The human-machine interface 1 according to the invention comprises at least one gripping element 10, such as a joystick or a command stick, also called “stick” or “grip”.

The gripping element 10 is provided with at least one transducer transmitting at least one command according to at least one input item of information, such as, for example, an angle of inclination of the gripping element 10 with respect to a reference position, a force applied on the gripping element 10, etc.

The human-machine interface 1 enables an operator, such as a pilot or a driver, to transmit commands to a vehicle, in particular an aircraft, a drone, a spacecraft, a construction machine, a motor vehicle, a ship, etc. Complementarily or alternatively, the human-machine interface 1 enables an operator, such as a pilot or a driver, to transmit commands to a tool, in particular in remote operation, in civil engineering, etc.

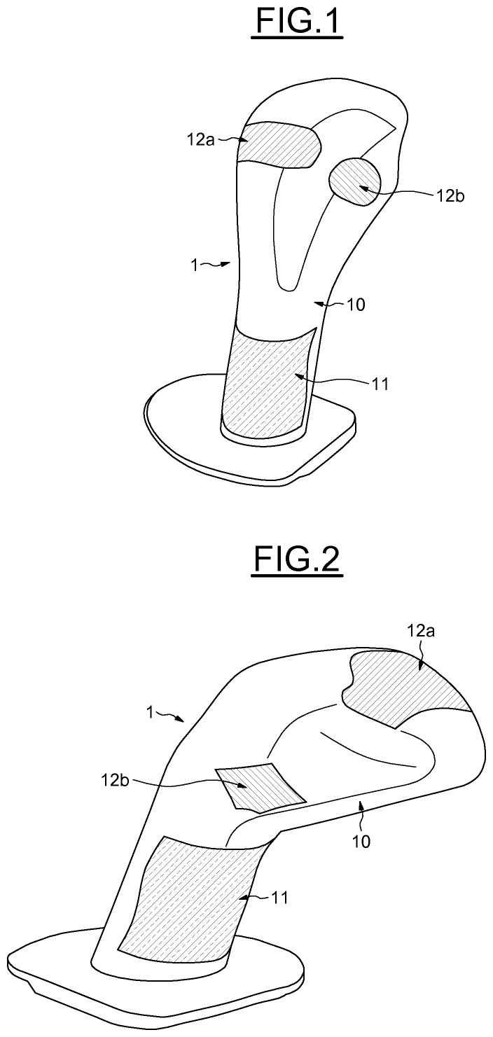

In a first embodiment illustrated in FIG. 1, the gripping element 10 is in the form of a joystick or command stick, also called “central stick” or “command stick”. The gripping element 10 comprises a transducer determining an angle of inclination forwards or rearwards and/or an angle of inclination leftwards or rightwards of the human-machine interface 1.

In a complementary or alternative particular embodiment, the gripping element 10 comprises a transducer determining an angle of rotation to the left or to the right and/or in a clockwise or counterclockwise direction of the human-machine interface 1.

In addition, the gripping element 10 may comprise a transducer determining a force exerted by the operator on the human-machine interface 1. The exerted force corresponds to an intensity applied by the operator and to a direction of application of the operator on the gripping element 10, such as in particular a pull, a push, a rotation . . .

In a second embodiment illustrated in FIG. 2, the gripping element 10 is in the form of a throttle control stick, also called “throttle stick” or “side stick”. Such a throttle control stick is used in particular in a 3M-type control system, acronym for hands on stick and joystick in French, also called “HOTAS”, acronym for “Hands on Throttle and Stick”.

Hence, the human-machine interface 1 provided with such a gripping element comprises a transducer determining an angle of inclination, an angle of rotation, a force, a direction of the gripping element 10, etc.

According to the invention, all or part of an external surface of the gripping element 10 is provided with at least one sensor, in particular a sensitive element, preferably with an array of at least one sensor, in particular an array of at least one sensitive element.

The sensor, in particular the sensitive element, is designed so as to transmit or emit a detection signal in response to an action carried out by the operator. Such an action carried out by the operator may be a press, a contact, a movement, a force applied by the operator on the sensor. More generally, the action carried out by the operator consists of an interaction between the operator and the gripping element 10 detected by the sensor, in particular the sensitive element, preferably the array of at least one sensor, in particular the array of at least one sensitive element.

The sensor may be of the capacitive, resistive or inductive type.

The human-machine interface 1 also comprises calculation means configured to determine a position of at least one surface of interaction between the operator and the gripping element 10, corresponding in particular to that in which the sensor emits or transmits the detection signal.

For example, the calculation means consist of software means duly programmed to determine the position of the sensor emitting or transmitting the detection signal.

The position of the sensor, in particular of the sensitive element, emitting or transmitting the detection signal is determined thanks to a unique addressing of the sensor.

The calculation means may be physically comprised in the human-machine interface 1 or be remotely arranged in a calculator connected to the human-machine interface 1, in particular to the array of sensors or sensitive elements and to the gripping element 10.

The calculation means may also be configured to determine whether the transmitted command, respectively the transmitted commands, is/are intentional or accidental. Indeed, the gripping element 10 may be touched without actually being grasped. This is the case, for example, during an erroneous movement by the operator, without the latter intending to generate a command.

To this end, the human-machine interface 1, in particular the gripping element includes at least one first predefined area 11. The first predefined area 11 allows determining whether an organ of the operator, advantageously a hand of the operator, is placed on the gripping element 10 in an interaction surface.

In particular, depending on a position of the surface of interaction with the operator and a position of the first predefined area 11, the calculation means compare the position of the surface of interaction with the operator with the position of the first predefined area 11. According to the invention, it is determined whether an overlap, at least partial, of the first predefined surface 11 is achieved by the surface of interaction with the operator.

Thus, the human-machine interface 1 allows differentiating between a handling error and an intentional command so as to ensure the operating safety of the vehicle or of the controlled device. In other words, it is possible to determine transparently for the operator whether a command made via the human-machine interface 1 is an intentional command or a handling error. If the command is intentional or voluntary, the calculation means authorise the transmission of commands by the human-machine interface 1.

Depending on the field of use of the human-machine interface 1, the intentional command detection condition may be limited to some commands of the human-machine interface 1.

In a particular embodiment, the first predefined area 11 is generally the portion of the human-machine interface 1 in contact with the palm of the hand of the operator.

For a gripping element 10 of the stick or joystick type, it generally consists of a base of the gripping element 10 over which the palm of the hand of the operator is pressed. It may be completed by lateral pressing areas and/or opposing areas.

For a gripping element 10 of the throttle control stick type, it generally consists of an upper portion of the gripping element 10 over which the palm of the hand of the operator rests.

Arranged this way, a hand of the operator hand detection function is thus achieved.

The human-machine interface 1, in particular the gripping element 10, may include at least one second predefined area 12a, in particular two second predefined areas 12a and 12b.

The second predefined area 12a, respectively the second predefined area 12b, allows making a command associated with conventional buttons, switches or contactors.

Thus, making of a command conventionally associated with buttons, switches or contactors may be achieved virtually by determining a contact and/or a press on the second predefined area 12a, respectively the second predefined area 12b.

Advantageously, the second predefined area 12a, respectively the second predefined area 12b, is distinct from the first predefined area 11 participating in the hand of the operator hand detection function.

To carry out a command conventionally associated with buttons and switches, the calculation means of the human-machine interface 1 may also be configured to determine whether the second predefined area 12a, respectively the second predefined area 12b, of the human-machine interface 1 is included, at least partially, in the surface of interaction with the operator.

To this end, the calculation means compare the position of the surface in contact with the operator with a position of the second predefined area 12a, respectively the second predefined area 12b.

According to the invention, it is determined whether an overlap, at least partial, of the second predefined area 12a, respectively the second predefined area 12b, is achieved by the surface of interaction with the operator.

If it results that such an overlap is achieved, the calculation means then emit or transmit the command associated with the second predefined area 12a, respectively with the second predefined area 12b, whose position is included at least partially in the surface of interaction with the operator.

Thus, the emission and/or the transmission of the command associated with the second predefined area 12a, respectively with the second predefined area 12b, is carried out in a manner similar to that of a press on a conventional button, switch or contactor of a conventional command interface.

It is possible to define several virtual contactors on the gripping element 10 of the human-machine interface 1, as well as several types of contactors. It is also possible to determine whether they are activated.

Different types of virtual contactors may be defined, like push-buttons, two-position switches, four-way contactors or multi-way analog contactors.

The human-machine interface 1 may also comprise at least one directional contactor determining a direction and/or an amplitude of a pressed movement of the operator according to an origin position, an end position of the pressed movement and the position of the predefined area. The directional contactor may be a two-position type one such as a switch, a four-position type one, or multi-directional.

Advantageously, the directional contactor is associated with the second predefined area 12a, respectively the second predefined area 12b, and/or the second predefined areas 12a and 12b.

FIGS. 1 and 2 illustrate embodiments including two second predefined areas 12a and 12b, which can be associated respectively with different contactors and/or with distinct commands.

It is also possible to transmit or emit a command associated with a simultaneous interaction, in particular a simultaneous press, over at least two predefined areas of the human-machine interface 1, such as the first predefined area 11, the second predefined area 12a, respectively the second predefined area 12b, and/or the second predefined areas 12a and 12b.

In another embodiment, the human-machine interface 1 comprises at least one informative layer allowing informing the operator of the position and/or of the command associated with at least one predefined area, such as the first predefined area 11, the second predefined area 12a, respectively the second predefined area 12b, and/or the second predefined areas 12a and 12b.

Such an informative layer may comprise an indication, in particular graphical, of the delimitation of the predefined area and/or of the command associated with the predefined area.

The human-machine interface 1 may also comprise means for illuminating at least one predefined area allowing highlighting and/or a visual feedback related to the command, an availability and/or an activation of the command.

In a particular case, the illumination means may consist of light-emitting diodes. They may then advantageously be combined with a liquid crystal layer. According to this particular configuration, it is then possible to combine the illumination function and the information function of the informative layer.

Alternatively, self-emissive devices, for example of the OLED type, an acronym for “Organic Light-Emitting Diode”, may be used to combine the illumination function and the information function in a single layer.

Moreover, the human-machine interface 1 may comprise information feedback means, in particular haptic information feedback means. The information feedback means allow warning the operator about the command associated with the predefined area.

In particular, the information feedback means allow informing the operator of an activation, an unavailability or an error related to the command associated with the predefined area.

A feedback, in particular a haptic information feedback, may be limited to the second predefined area 12a, respectively the second predefined area 12b, or associated with all or part of the human-machine interface 1, in particular of the gripping element 10.

The first predefined area 11 and the second predefined area 12a, respectively the second predefined area 12b, are defined so as to be decorrelated from a physical structure of the gripping element 10 of the human-machine interface 1. Consequently, the position of the first predefined area 11 and of the second predefined area 12a, respectively the second predefined area 12b, may be modified according to the device or the vehicle to which the human-machine interface 1 is connected, or be modified during operation according to external parameters.

For example, the commands of the human-machine interface 1 may change according to the flight phase of an aircraft, so as to prioritise access to the relevant commands for the considered flight phase.

Different embodiments have been independently described hereinabove. Of course, the invention is not limited to the embodiments described before and provided only as example. It should nevertheless be understood that they could be used separately or combined together depending on the intended use of the human-machine interface 1. The invention encompasses various modifications, alternative forms and other variants that a person skilled in the art could consider in the context of the invention and in particular all combinations of the different operating modes described before, which may be considered separately or in combination.

1. A human-machine interface for a vehicle or for a device, the human-machine interface comprising:
at least one gripping element for transmission of a command according to at least one item of input information, the at least one item of input information comprising an angle of inclination or an angle of rotation of the gripping element with respect to a reference position and/or a force, an effort or a direction applied to the gripping element,
at least one sensor comprising an array of sensitive elements disposed over at least one portion of an external surface of the gripping element and configured to transmit a detection signal following an action carried out by an operator on the gripping element, and
calculation means configured to determine a position of at least one interaction surface between the operator and the gripping element, the calculation means being configured to determine whether the command is intentional by determining whether at least one first predefined area is included at least partially in the interaction surface, so as to authorise transmission of the command by the human-machine interface when it is determined that the command is intentional.

2. The human-machine interface according to claim 1, wherein the at least one sensor is of a capacitive, resistive or inductive type.

3. The human-machine interface according to claim 1, further comprising at least one second predefined area distinct from the first predefined area, wherein the calculation means are configured to transmit the command associated with the second predefined area if the second predefined area is included at least partially in the interaction surface.

4. The human-machine interface according to claim 1, further comprising at least one directional contactor, wherein the calculation means are configured to determine a pressed movement of the operator on the directional contactor in at least one predefined area according to an origin position, an end position of the pressed movement and to transmit a command different from the command emitted during a simple press on the predefined area.

5. The human-machine interface according to claim 4, wherein the calculation means are configured to transmit a command associated with a simultaneous interaction on at least two predefined areas.

6. The human-machine interface according to claim 1, further comprising at least one information layer comprising a delimitation and/or command indication associated with at least one predefined area.

7. The human-machine interface according to claim 1, further comprising means for illuminating at least one predefined area.

8. The human-machine interface according to claim 1, further comprising information feedback means allowing warning the operator about a command associated with the predefined area.

9. A vehicle, controlled by a human-machine interface according to claim 1, wherein the vehicle is at least one of: an aircraft, a drone, a spacecraft, a construction machine, a motor vehicle, or a ship.
